(19) United States
(12) Patent Application Publication
(10) Pub. No.: US 2007/0219860 A1
(43) Pub. Date: Sep. 20, 2007

(54) Presenting advertising information requested from a webpage

(75) Inventor: Jason Karls, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/384,466

(22) Filed: Mar. 20, 2006

(51) Int. Cl. G06Q 30/00

(52) U.S. Cl. 705/14

(57) ABSTRACT

Methods and systems for presenting advertising information in association with a web page from which such information is requested, the web page being part of a plurality of web pages having a relationship with one another (e.g., an advertising/publishing network) are provided. Advertising information may include prospective or historical information derived from a particular advertisement or a plurality of advertisements presented in association with the web page and/or other similar web pages, or information about one or more advertisements driving traffic to the web page. Additionally, methods and systems are provided for presenting an advertisement in association with a web page from which such presentation is requested, the web page being part of a plurality of web pages having are relationship with one another.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The Internet has become a global electronic marketplace for goods and services. Search engines have been developed to index and search the information available on the Internet allowing consumers to locate information of interest quickly and efficiently. These search engines enable consumers to search the Internet for a listing of websites or web pages based upon a specific product or service, or based upon a general topic of interest. To utilize such search engines, a consumer enters a search term that includes one or more keywords which the search engine then uses to generate a list of web pages relevant to the search term. Currently, websites providing search services offer advertisers significant reach into the Internet by giving them the opportunity to target consumer interests based on these search terms. For instance, an advertiser can purchase keywords from a search engine so that when a consumer enters a search term that includes one or more of the purchased keywords, the search engine not only displays the list of web pages relevant to the search term but also displays an advertisement selected by the advertiser who purchased one or more of the keywords within the user's search term.

Another form of advertising offered by search engines and web publishers is contextual advertising. Rather than purchasing keywords that will display advertisements on a search results page, the approach of contextual advertising is from within the actual web pages themselves. Contextual advertising displays advertisements based on keywords present within the content of a web page that is being viewed. The system will examine the content of the web page a consumer is currently viewing for specified keywords and display advertisements in association with any content found to contain the specified keywords.

One drawback of the above-described keyword-based methods is that it is difficult for advertisers to specify that they want an advertisement to be displayed in association with a specific web page, that is, a web page identified by a specific URL. For example, if a business that sells sunglasses would like to place an advertisement for their business on a specific web page that contains an article on the damaging effects of the sun's rays, neither of the above-described methods can guarantee this result. Another drawback of the keyword-based methods is that they do not allow a user at a specific web page to easily access information regarding placing an advertisement on the web page and/or about how an already placed advertisement on the web page may be performing. Such actions must be performed by navigating to a different web page designed specifically for this purpose. And one challenge with performing such actions from a different web page is that there is not a visual or direct relationship between a click event and the web page that it came from. As an advertiser is not connected directly to the click event's point of origin, presentation of advertising information across a number of advertisements and their associated web pages is often difficult to achieve.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In embodiments, advertising information relevant to a particular web page may be requested by a user at the web page and presented in association therewith. Such advertising information may include prospective or historical information derived from a particular advertisement or a plurality of advertisements presented in association with the web page and/or other similar web pages. Additionally, advertising information may include information about one or more advertisements driving traffic to the web page. By way of example, advertising information may include an expected or historical number of impressions, an expected or historical click-through rate, an expected or historical cost-per-click, and expected or historical budgeting information. In additional embodiments, a user at the web page may create an advertisement or select an existing advertisement to be presented in association with the web page.

### BRIEF DESCRIPTION OF THE SEVERAL VIEWS OF THE DRAWINGS

The present invention is described in detail below with reference to the attached drawings figures, wherein:

FIG. 1 is a block diagram of an exemplary operating environment suitable for use in implementing embodiments of the present invention;

FIG. 2 is a block diagram of an exemplary system architecture for use in implementing embodiments of the present invention;

FIG. 3 is a flow diagram, in accordance with an embodiment of the present invention, illustrating a method for presenting advertising information in association with a web page in response to a user at the web page requesting the advertising information;

FIG. 4 is a flow diagram, in accordance with an embodiment of the present invention, illustrating a method for presenting an advertisement in association with a web page in response to a user at the web page creating or selecting the advertisement;

FIG. 5 is a screen display of an exemplary web page having an advertising toolbar associated therewith, in accordance with an embodiment of the present invention;

FIG. 6 is a screen display of an exemplary user interface from which a user's authorization to view advertising information and/or create or select an advertisement for presentation in association with a web page may be verified, in accordance with an embodiment of the present invention;

FIG. 7 is a screen display of an exemplary view illustrating visual presentation of advertising information in association with a web page from which the advertising information was requested, in accordance with an embodiment of the present invention; and

FIG. 8 is a screen display of an exemplary user interface from which an advertisement may be created or an existing advertisement may be selected for presentation in association with a web page, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems and methods for presenting advertising information relevant to a particular web page in association therewith, such advertising information being requested by a user at the web page. For instance, a user interested in placing an advertisement for sunglasses that his or her business would like to sell may be browsing through various web pages and come across an article on the damaging effects of the sun's rays displayed on a particular web page. The user may decide s/he'd like to place an advertisement on the page but would like to evaluate some information relevant to placing the advertisement prior to making a final determination. Accordingly, from the web page, the user may request such advertising information for presentation, for instance, by selecting a button on an advertising toolbar displayed in association with the web page. Advertising information may include, without limitation, prospective or historical information derived from a particular advertisement or a plurality of advertisements presented in association with the web page and/or other similar web pages. Additionally, advertising information may include information about one or more advertisements that drive traffic to the web page.

Additional embodiments of the present invention provide systems and methods that permit advertisements to be created and/or selected for presentation in association with the particular web page by a user at the web page. The user request for creation and/or selection of an advertisement for presentation may be initiated, e.g., upon selection of a button on an advertising toolbar displayed in association with the web page.

Accordingly, in one aspect, an embodiment of the present invention is directed to a method for presenting advertising information in association with a web page that is part of a plurality web pages having a relationship with one another, e.g., a plurality of web pages that are part of an advertising/publishing network. The method includes receiving a request for advertising information about the web page from a user at the web page, accessing the requested advertising information from a database, and presenting the accessed advertising information in association with the web page. If desired, the method may further include verifying that the user is authorized to receive the requested advertising information prior to accessing the information.

In another aspect, an embodiment of the present invention is directed to a method for presenting an advertisement in association with a web page that is part of a plurality of web pages having a relationship with one another, e.g., a plurality of web pages that are part of an advertising/publishing network. The method includes receiving a request from a user at the web page to have the advertisement presented in association with the web page, presenting, in association with the web page, a user interface for configuring the advertisement, receiving an indication that the configuration of the advertisement is complete, and presenting the advertisement in association with the web page. If desired, the method may further include verifying that the user is authorized to configure the advertisement prior to presenting the user interface for configuring the advertisement.

Embodiments of the present invention are further directed to computer-readable media having computer-executable instructions for performing the methods disclosed herein.

A further embodiment of the present invention is directed to a system for presenting advertising information and/or an advertisement in association with a web page that is part of a plurality of web pages having a relationship with one another, e.g., a plurality of web pages that are part of an advertising/publishing network. The system includes a request receiving component for receiving a request from a user at the web page for advertising information about the web page and/or presentation of an advertisement in association with the web page, and a presentation component for presenting the advertising information about the web page and/or the advertisement in association with the web page. The system may further include an accessing component for accessing, from one or more databases, requested advertising information and/or user account information. Still further, the system may include a user authorization component for verifying that the user is authorized to receive requested advertising information about the web page and/or configure the advertisement for presentation in association with the web page.

Having briefly described an overview of the present invention, an exemplary operating environment for the present invention is described below.

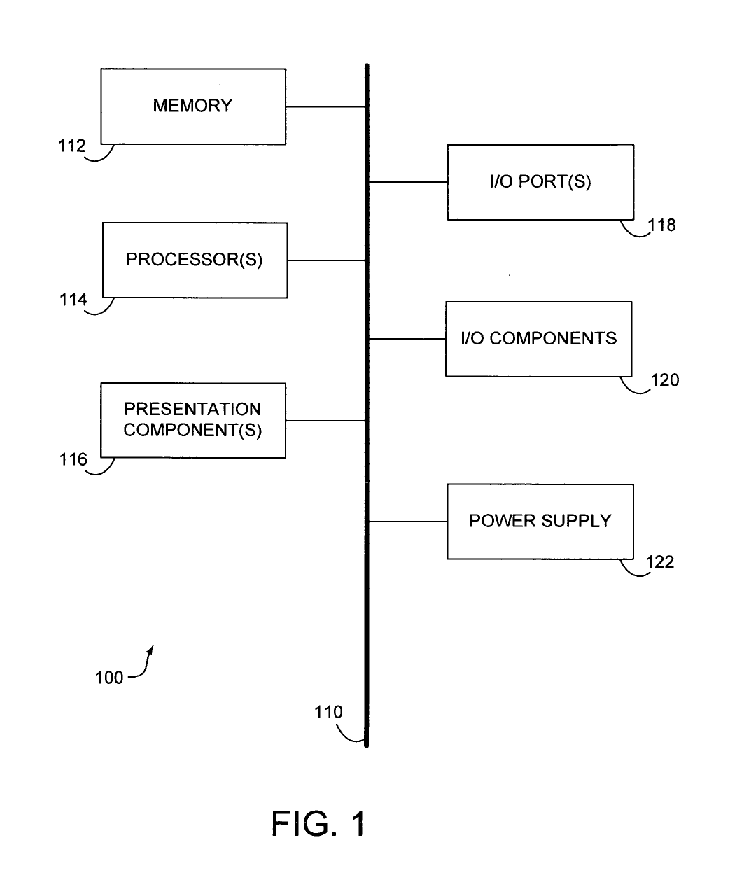

Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It is recognized that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

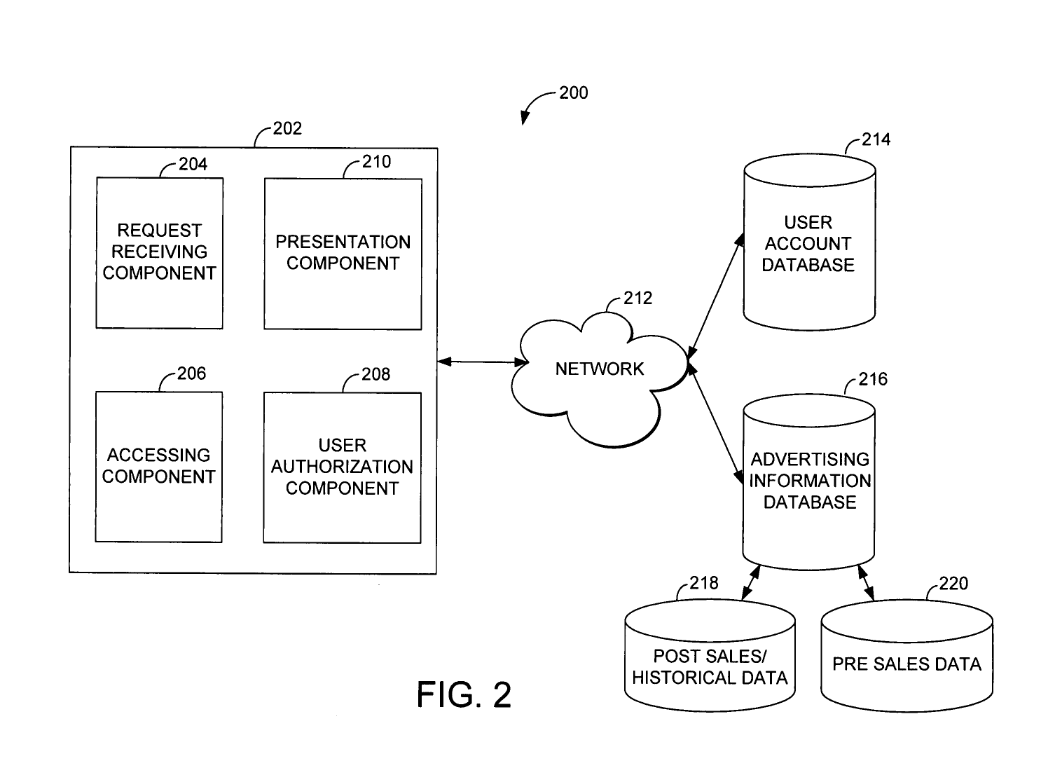

Referring now to FIG. 2, a block diagram is illustrated that shows an overall system architecture 200 for requesting advertising information from a web page and/or creating or selecting an advertisement for presentation in association with a web page from which such creation/selection is initiated. As used herein, the term “advertising information” may include, without limitation, prospective or historical information derived from a particular advertisement or a plurality of advertisements presented in association with a particular web page (that is, a web page associated with a particular URL) and/or other similar web pages. Additionally, advertising information may include information about one or more advertisements driving traffic to the web page from which such information is requested. By way of example, advertising information may include an expected or historical number of impressions, an expected or historical click-through-rate, an expected or historical cost-per-click, and expected or historical budgeting information. It will be understood and appreciated by those of ordinary skill in the art that the overall system architecture 200 shown in FIG. 2 is merely an example of one suitable computing environment and is not intended to suggest any limitation as to the scope of use or functionality of the present invention. Neither should the overall system architecture 200 be interpreted as having any dependency or requirement relating to any single component or combination of components illustrated therein.

System 200 includes a user device 202 connected to a network 212. The user device 202 shown in FIG. 2 may be any type of computing device, such as, for example, computing device 100 described above with reference to FIG. 1. By way of example only and not limitation, the user device 202 may be a user's personal computer, desktop computer, laptop computer, handheld device, consumer electronic device, and the like. It should be noted, however, that the invention is not limited to implementation on such computing devices, but may be implemented on any of a variety of different types of computing devices within the scope of embodiments of the present invention.

As shown in FIG. 2, a number of components reside on the user device for implementing embodiments of the present invention, including a request receiving component 204, an accessing component 206, a user authorization component 208 and a presentation component 210. In some embodiments, the components may be implemented as stand-alone applications. In other embodiments, the components may be integrated directly into the operating system for the user device 202.

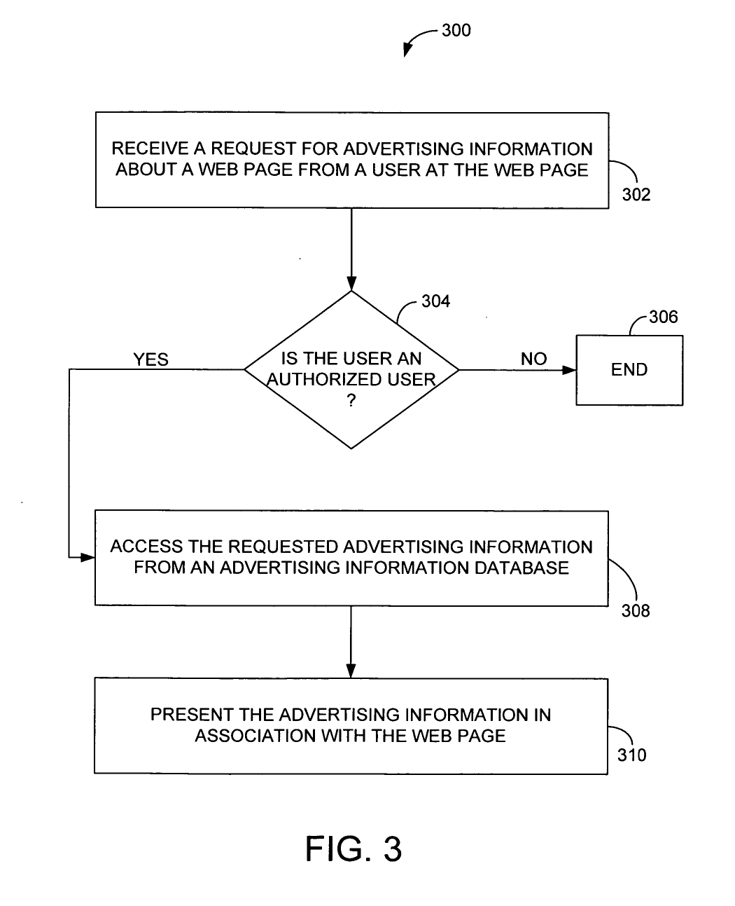

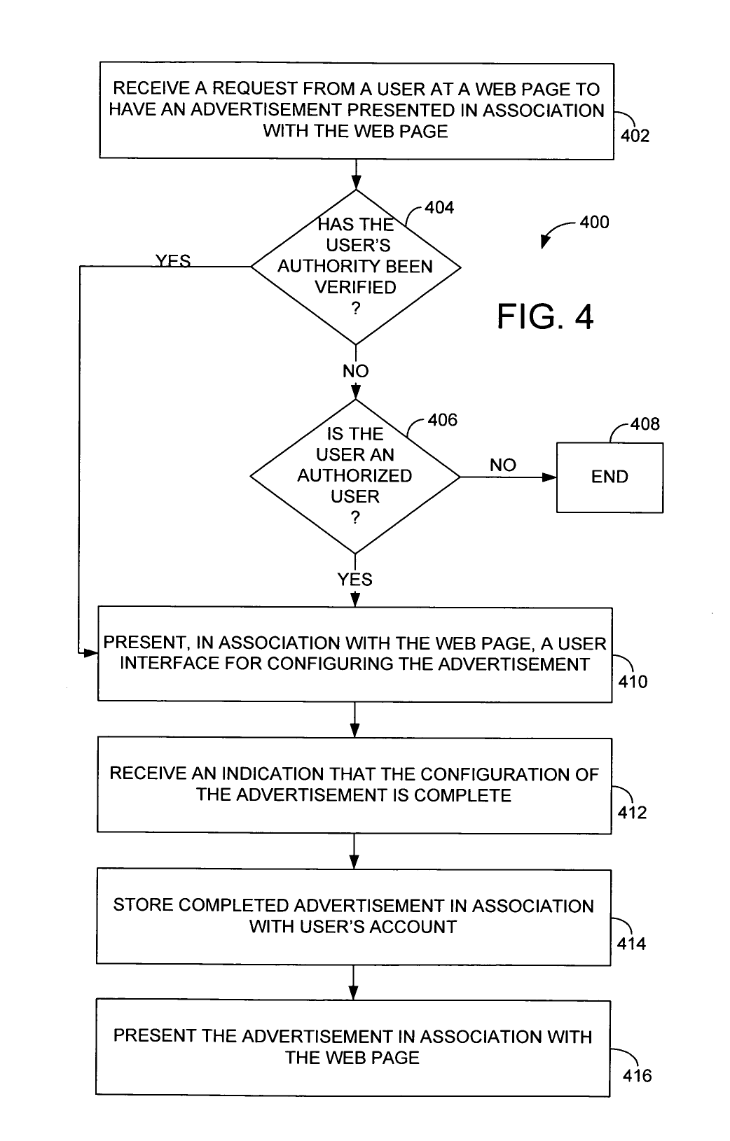

The request receiving component 204 may be provided for receiving a request, from a user at a web page, for advertising information relevant to the web page to be presented in association therewith. Such advertising information may be prospective or historical and may be requested with respect to a number of criteria including, without limitation, a particular advertisement previously presented in association with the web page, a plurality of advertisements previously presented in association with the web page, and/or one or more advertisements driving traffic to the web page. The request receiving component 204 may additionally be provided for receiving a request, from a user at a web page, to create an advertisement or select an existing advertisement for presentation in association with the web page. As more fully described below with reference to FIGS. 3 and 4, such requests may be initiated upon user selection of an appropriate button on an advertising toolbar displayed in association with the web page.

Accessing component 206 may be provided for accessing requested advertising information and/or user account information. In some embodiments, accessing component 206 may access requested advertising information from or more remote databases, e.g., advertising information database 216, post sales/historical data database 218, and/or presales data database 220 (e.g., via network 212). In other embodiments, accessing component 206 may access requested advertising information stored on the user device 202, for instance, in an advertising database (not shown) maintained in association therewith. In such embodiments, an advertising server (not shown) may periodically communicate advertising information to the user device 202 for updating the information stored in the advertising information database maintained in association therewith.

Additionally, in some embodiments, accessing component 206 may access requested user account information (e.g., a list of authorized users, existing advertisements, user advertising preferences, and the like) from one or more remote databases, e.g., user account database 214 (e.g., via network 212). In other embodiments (not shown), accessing component 206 may access requested user account information stored on the user device 202, for instance, in a user account database (not shown) maintained in association therewith. In such embodiments, an advertising server (not shown) may periodically communicate user account information to the user device 202 for updating the information stored in the user account information database maintained in association therewith.

User authorization component 208 may be provided for verifying a user's authority to receive requested advertising information and/or configure (e.g., create or select) an advertisement for presentation in association with the web page. In some embodiments, user authorization component 208 may access user account information (e.g., a list of authorized users, existing advertisements, user advertising preferences, and the like) from one or more remote databases, e.g., user account database 214 (e.g., via network 212). In other embodiments (not shown), user authorization component 208 may access user account information stored on the user device 202, for instance, in a user account database (not shown) maintained in association therewith. In such embodiments, an advertising server (not shown) may periodically communicate user account information to the user device 202 for updating the information stored in the user account database maintained in association therewith.

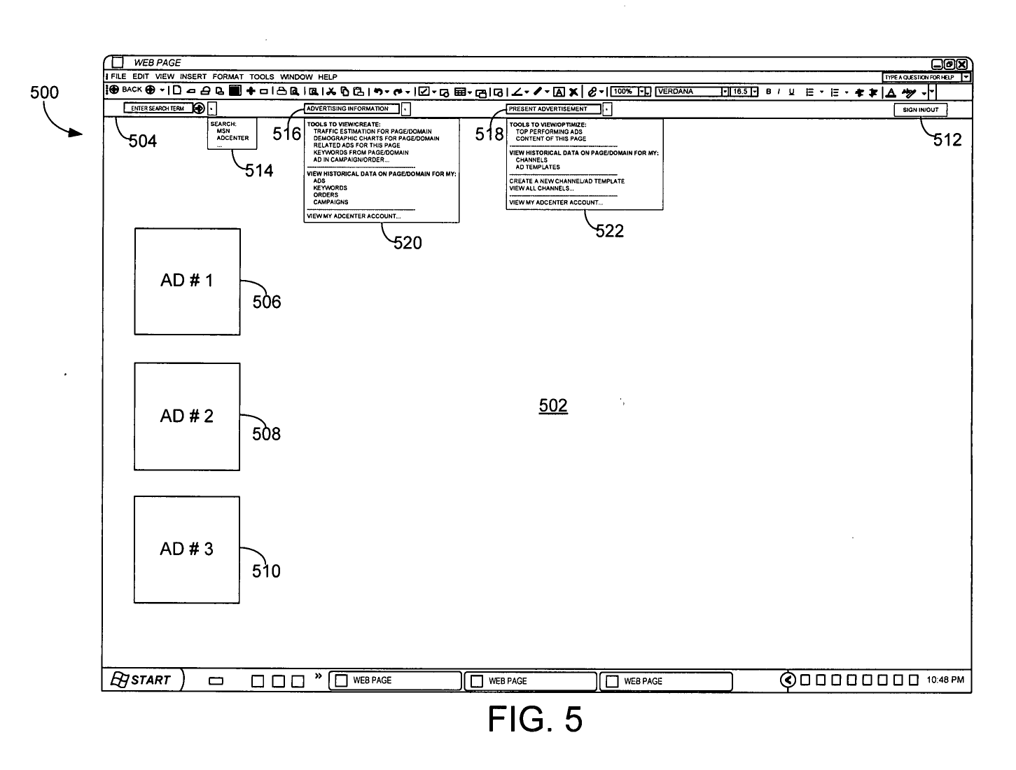

Presentation component 210 may be provided for presenting requested advertising information and/or created or selected advertisements in association with the web page. Presentation component 210 may additionally be provided for presenting a variety of user interfaces (e.g., those user interfaces shown in FIGS. 5-8) in association with the web page. In some embodiments, presentation component 210 may access the requested advertising information and/or user account information (e.g., a list of authorized users, existing advertisements, user advertising preferences, and the like) from one or more remote databases, e.g., user account database 214, advertising information database 216, post sales/historical data database 218 and/or presales data database 220 (e.g., via network 212). In other embodiments (not shown), presentation component 210 may access advertising information and/or user account information stored on the user device 202, for instance, in a user account database (not shown) and/or an advertising information database (not shown). In such embodiments, an advertising server (not shown) may periodically communicate user account and/or advertising information to the user device 202 for updating the information stored in the database(s) maintained in association therewith. Typically, presentation of advertising information and/or advertisements comprises displaying such information and/or advertisement on a display device associated with the user device 202. However, other types of presentation, such as an audible presentation, may also be provided within the scope of the present invention. Additionally, it will be understood and appreciated by those of ordinary skill in the art that presentation may include presentation to forms of advertising media other than web pages, e.g., billboard/storefronts, television/radio, magazines/journals, and the like. Any and all such combinations are contemplated to be within the scope of the methods and systems of the present invention.

It will be understood by those skilled in the art that the components 204, 206, 208, and 210 and databases 214, 216, 218, 220 illustrated in FIG. 2 are exemplary in nature and in number and should not be construed as limiting. Any number of components may be employed to achieve the desired functionality and any number of databases may be utilized to store information within the scope of embodiments of the present invention.

Advertising information stored in advertising information database 216, post sales/historical data database 218, and presales data database 220 may be generated in a variety of ways within the scope of the present invention. Typically, advertising information stored in the illustrated databases 216, 218, 220 is statistical information compiled from a plurality of web pages having a relationship with one another. For instance, in one embodiment, the plurality of web pages are part of an advertising/publishing network of web pages. That is, each of the plurality of web pages is part of a network of web pages about which an entity maintaining the databases 216, 218, 220 has access to statistical information about prospective and/or historical advertising performance. As previously stated, such statistical information may include, without limitation, prospective or historical numbers of impressions, click-through-rates, cost-per-clicks, and budgeting information. In one embodiment, the post sales/historical data database 218 has stored therein at least a portion of the relevant historical information (e.g., historical numbers of impressions, historical click-through-rates, historical cost-per-click information, and historical budgeting information), the presales data database 220 has stored therein at least a portion of the relevant prospective information (e.g., expected numbers of impressions, expected click-through-rates, expected cost-per-click information, and expected budgeting information), and the advertising information database 216 is in communication with both the post sales/historical data database 218 and the presales data database 220 and has stored therein at least a portion of both the historical and prospective information.

User account information stored in the user account database 214 may also be generated in a variety of ways within the scope of the present invention. Typically, user account information stored in the user account database 214 is information about a plurality of users that have established accounts in order to view advertising information regarding, and/or configure advertisements for, a plurality of web pages having a relationship with one another, for instance, web pages that are part of an advertising/publishing network of web pages. As previously stated, such user account information may include, without limitation, a list of authorized users, existing advertisements (either previously displayed on a web page that is part of the network of web pages or that has been configured for future display), and advertising preferences.

Turning to FIG. 3, a flow diagram is illustrated that shows an exemplary method 300 for presenting advertising information in association with a web page in response to a user at the web page requesting such advertising information. Initially, as indicated at block 302, a request for advertising information is received from a user at a web page that is part of a network of web pages having a relationship with one another (e.g., a plurality of web pages that are part of an advertising/publishing network). Such request may be received, for example, by request receiving component 204 (FIG. 2) upon user selection of an appropriate button on an advertising toolbar, e.g., “advertising information” button 516 of advertising toolbar 504 shown in FIG. 5 (and more fully described below), displayed in association with the web page.

In one embodiment, the request for advertising information received at block 302 may be initiated by a user inquiring prospectively about performance of advertisements presented in association with the web page in general. In another embodiment, the request for advertising information may be initiated by a user inquiring about the historical performance of a particular advertisement or a plurality of advertisements previously presented in association with the page. In still another embodiment, the request for advertising information may be initiated by a user inquiring about performance of one or more advertisements driving traffic to the web page. All such variations are contemplated to be within the scope of embodiments of the present invention.

With reference to FIG. 5, an exemplary screen display suitable for use in implementing embodiments of the present invention is shown and designated generally as reference numeral 500. It will be understood and appreciated by those of ordinary skill in the art that screen display 500 is provided by way of example only and it is not intended to limit the scope of the present invention in any way.

Screen display 500 is identified by a specific URL and includes a content display area 502 and an advertising toolbar 504. Screen display 500 additionally includes a first advertisement 506, a second advertisement 508, and a third advertisement 510 displayed in association with the content display area 502. It will be understood and appreciated by those of ordinary skill in the art that the placement of advertisements 506, 508, 510 is merely exemplary in nature and that advertisements may be displayed at any location within the content display area 502. In one embodiment (not shown), advertisements 506, 508, 510 may be displayed vertically along the right-hand side of content display area 502 rather than the left-hand side as shown. Content display area 502 is configured to display the content of the web page identified by the specific URL, the web page being part of a plurality of web pages having a relationship with one another. In one embodiment, the plurality of web pages are part of an advertising/publishing network. The advertising toolbar 504 may be provided as part of a client software application and includes, by way of example only, a selectable search service identifier 514, a selectable “advertising information” button 516 for requesting advertising information relevant to the web page, expansion of which initiates display of a drop down menu 520 of options related thereto, and a selectable “present advertisement” button 518, expansion of which initiates display of a drop down menu 522 of options related thereto. Upon user selection of one of the expanded options of the “advertising information” button 516, a request for advertising information is initiated and received (for instance, by request receiving component 204 of FIG. 2) as indicated at block 302 of FIG. 3. Upon user selection of one of the expanded options of the “present advertisement” button 518, a request for presentation of an advertisement in association with the web page is initiated and received, as more fully described below with reference to FIG. 4. The advertising toolbar 504 additionally includes a selectable “sign in/out” button 512, selection of which initiates a user authorization functionality, as more fully described below.

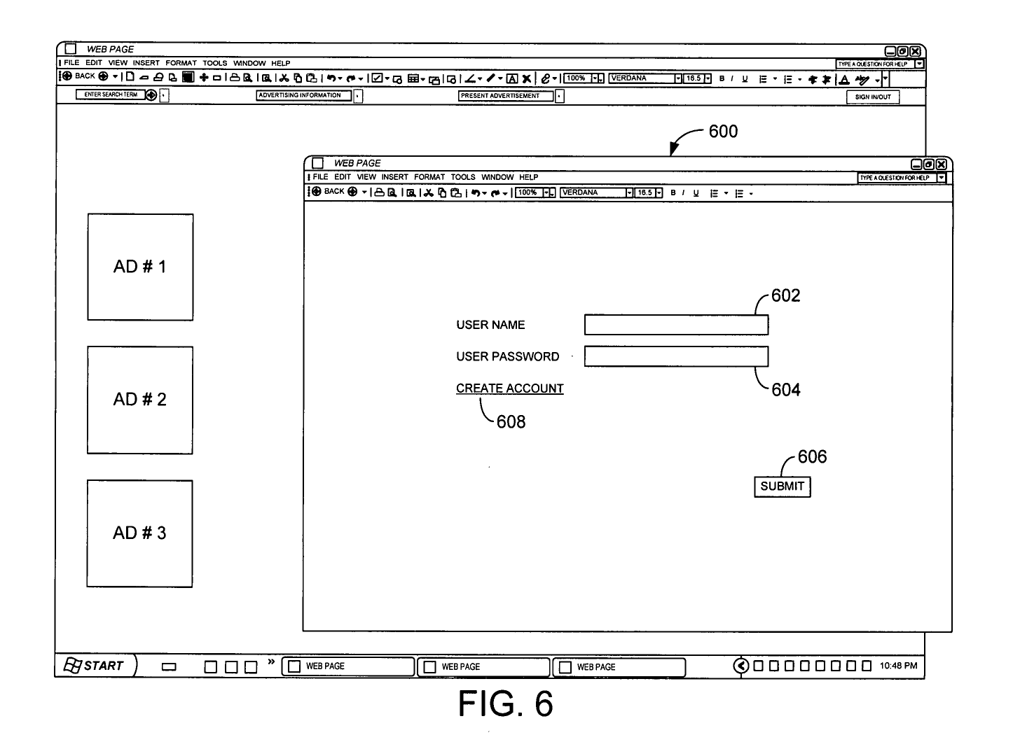

With reference back to FIG. 3, it is subsequently determined whether the user initiating the request for advertising information is authorized to receive the requested advertising information, as indicated at block 304. Such determination may be made, for instance, by user authorization component 208 (FIG. 2) querying the user account database 214 (via network 212) for user account information associated with the requesting user. Relevant information necessary to verify a requesting user's authority may be gathered by way of a user interface, for instance, user interface 600 shown in FIG. 6 and more fully described below. Such relevant information may include, by way of example only, a user's login identification (e.g., name) and password.

With reference to FIG. 6, a screen display of an exemplary user interface from which a user's authorization to view advertising information may be verified, in accordance with an embodiment of the present invention, is illustrated and designated generally as reference numeral 600. It will be understood and appreciated by those of ordinary skill in the art that the screen display 600 of FIG. 6 is provided by way of example only and it is not intended to limit the scope of the present invention in any way. In the embodiment described with reference to FIG. 3, screen display 600 may be initiated upon receiving a request for advertising information about a web page from a user at the web page, e.g., upon user selection of one of the expanded options of the “advertising information” button 516 of advertising toolbar 504 of FIG. 5. In another embodiment (not shown), screen display 600 may be initiated upon user selection of the “sign in/out” button 512 of advertising toolbar 504 of FIG. 5, whether or not such selection is associated with a request for advertising information being received. Any and all such variations, and combinations thereof, are contemplated to be within embodiments of the present invention.

Screen display 600 includes a field 602 for input of a user's login identification (e.g., user name) and a field 604 for input of a user's password. In one embodiment, a user having an identification and a password, may input such information into the appropriate fields 602 and 604 and subsequently select the “submit” indicator 606 to initiate verification of the user's authorization to view the advertising information requested at block 302 of FIG. 3. If a user does not already have an identification and password, he or she may create an account by selecting “create account” link 608. Methods for establishing an account for permitting access to protected information are known to those of ordinary skill in the art and, accordingly, are not further described herein.

If it is determined that the user initiating the request for advertising information is not an authorized user, the information is not presented and the method 300 is terminated. This is indicated at block 306 of FIG. 3. It will be understood and appreciated by those of ordinary skill in the art that, if desired, the user may be prompted to create a user account which may allow him or her access to the requested information upon selection of a “create account” button or link (e.g., a link similar to the “create account” link 608 of FIG. 6) that may be present on the user interface. Additionally, if desired, if it is determined that the user initiating the request for advertising information is not an authorized user, a screen display (not shown) indicating such may be presented in association with the web page from which the request for advertising information was initiated. All such variations are contemplated to be within the scope of embodiments of the present invention.

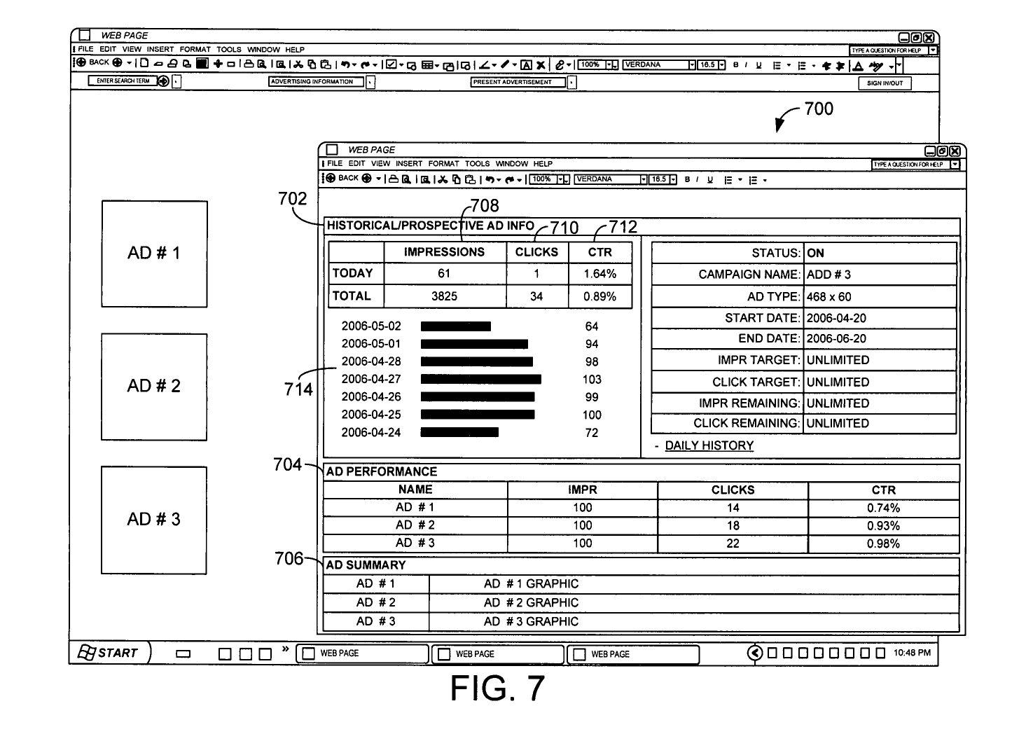

If, on the other hand, it is determined that the user initiating the request for advertising information is an authorized user, the requested information is accessed (e.g., upon a query from accessing component 206 to advertising information database 216 via network 212 of FIG. 2). This is indicated at block 308. Subsequently, the requested advertising information may be presented in association with the web page from which the request for information was initiated, as indicated at block 310. Presentation of the requested advertising information may be accomplished in a variety of different ways within the scope of embodiments of the present invention. Typically, the presentation includes displaying the requested advertising information within a graphical user interface. One such graphical user interface is shown in the screen display of FIG. 7 and designated generally as reference numeral 700. It will be understood and appreciated by those of ordinary skill in the art that the screen display of FIG. 7 is provided by way of example only and is not intended to limit the scope of the present invention in any way.

User interface 700 includes an historical/prospective advertising information display area 702 configured to display historical and/or prospective advertising information, an advertising performance display area 704 configured for comparing the performance of multiple advertisements currently or previously displayed in association with the web page, and an advertisement summary display area 706 configured to display selectable links to advertisements currently or previously displayed in association with the web page. The historical/prospective advertising information display area 702 includes a number of impressions display area 708 configured to display a historical or expected total number of impressions for a particular advertisement (including a current daily total as well as a life-of-the-advertisement total), a number of clicks display area 710 configured to display a historical or expected total number of clicks for a particular advertisement (including a current daily total as well as a life-of-the-advertisement total), and a click-through-rate display area 712 configured to display a historical or prospective click-through-rate for a particular advertisement (including a current daily rate and a life-of-the-advertisement rate). Additionally, the historical/prospective advertising information display area 702 includes a daily history display area 714 for graphically displaying the number of impressions throughout the life of the advertisement. It will be understood by those of ordinary skill in the art that the daily segments of time illustrated in FIG. 7 are exemplary in nature and that any and all possible segments of time (e.g., hourly, weekly, monthly, etc.) may be displayed within the scope of embodiments of the present invention.

It will be understood and appreciated by those of ordinary skill in the art that each of the illustrated display areas (e.g., display areas 708, 710, 712 and 714) may include historical or prospective information or may be blank or include no information depending upon their applicability. For instance, if a user is inquiring about past performance of an advertisement currently shown on the associated web page, the number of impressions display area 708, the number of clicks display area 710, the click-through-rate display area 712, and the daily history display area 714 may all display historical information related to the particular advertisement. If, however, a user is inquiring prospectively about expected performance of an advertisement s/he would like to present in association with the web page, each of the number of impressions display area 708, the number of clicks display area 710 and the click-through-rate display area 712 may display prospective information related to the particular advertisement and the daily history display area 714 may be blank. All such variations, and any combination thereof, are contemplated to be within the scope of the present invention. Additionally, further information (e.g., status, name, display dates, etc.) may be displayed in the historical/prospective advertising information display area 702 (as shown in FIG. 7), if desired.

Turning now to FIG. 4, a flow diagram is illustrated which shows a method for presenting an advertisement in association with a web page to a user at the web page creating or selecting the advertisement. Initially, as indicated at block 402, a request to have an advertisement presented in association with a web page that is part of a network of web pages having a relationship with one another (e.g., a plurality of web pages that are part of an advertising/publishing network) is received from a user at the web page. By way of example only, such request may be initiated upon selection of an appropriate button on a toolbar displayed in association with the web page. For instance, with reference back to FIG. 5, the advertising toolbar 504 may include, by way of example only, a selectable “present advertisement” button 518 for initiating configuration of an advertisement for presentation in association with a web page. Upon user selection of the “present advertisement” button 518 (or one of the expanded options of the dropdown menu 522 associated therewith), a request for configuration of an advertisement is initiated and received (for instance, by request receiving component 204 of FIG. 2) as indicated at block 402 of FIG. 4.

Subsequently, as indicated at block 404, it is determined whether the authority of a user initiating the request to have the advertisement presented has been verified. Such authority may have been verified, for instance, if the user had requested advertising information about the web page (e.g., utilizing method 300 of FIG. 3) prior to initiating the request to have the advertisement presented in association with the page or if the user had signed in by selecting the “sign in/out” button 512 of toolbar 504 of FIG. 5. If it is determined that the user's authority has not been verified, it is next determined whether the user is authorized to request presentation of an advertisement in association with the web page. This is indicated at block 406. Such determination may be made, for instance, by user authorization component 208 (FIG. 2) querying the user account database 214 (via network 212) for user account information associated with the requesting user. Relevant information necessary to verify a requesting user's authority may be gathered by way of a user interface and may include, by way of example only, a user's login identification (e.g., name) and password.

With reference back to FIG. 6, in one embodiment, a user having an identification and a password, may input such information into the appropriate fields 602 and 604 and subsequently select the “submit” indicator 606 to initiate verification of the user's authorization to place an advertisement in association with the web page. If a user does not already have an identification and password, he or she may create an account by selecting “create account” link 608.

If it is determined that the user initiating the request to have an advertisement placed in association with the web page is not an authorized user, the information is not presented and the method 400 is terminated. This is indicated at block 408 of FIG. 4. It will be understood and appreciated by those of ordinary skill in the art that, if desired, the user may be prompted to create a user account which may allow him or her to place an advertisement upon selection of a “create account” button or link (e.g., a link similar to the “create account” link 608 of FIG. 6) that may be present on the user interface. Additionally, if desired, if it is determined that the user initiating the request to place an advertisement is not an authorized user, a screen display (not shown) indicating such may be presented in association with the web page from which the request to place an advertisement was initiated. All such variations are contemplated to be within the scope of embodiments of the present invention.

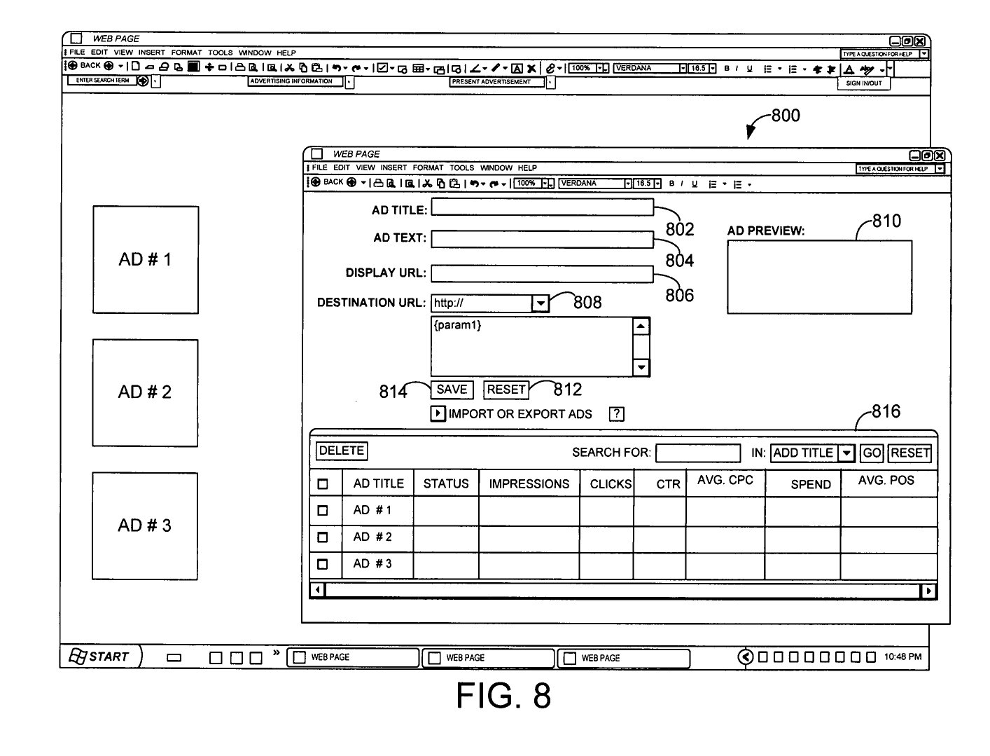

If, on the other hand, it is determined that the user initiating the request to place an advertisement in association with the web page is an authorized user (or if it is determined at block 404 that the user's authority has already been verified), a user interface for configuring the advertisement may be presented in association with the web page. This is indicated at block 410. One exemplary user interface is the user interface displayed in association with configuring an advertisement in AdCenter, a product offered by Microsoft Corporation of Redmond, Wash. Configuration criteria may include, by way of example only, an advertisement graphic, desired placement of the advertisement on the web page, the number of impressions allowed, the number of clicks allowed, and a desired budget. In one embodiment, the user may select a previously configured advertisement. An exemplary user interface for configuring an advertisement for placement in association with a web page is illustrated in screen display 800 of FIG. 8, which is more fully described below.

Turning now to FIG. 8, a screen display of an exemplary user interface from which an advertisement may be created or an existing advertisement may be selected for presentation in association with a web page, in accordance with an embodiment of the present invention, is illustrated and designated generally by reference numeral 800. It will be understood and appreciated by those of ordinary skill in the art that the screen display of FIG. 8 is provided by way of example only and it is not intended to limit the scope of the present invention in any way.

Screen display 800 includes a field 802 for inputting an advertisement title, a field 804 for inputting advertisement text, a field for inputting a display URL, a field 808 for inputting a destination URL 808, an advertisement preview display area 810 configured to display information about an advertisement currently selected or being created, and an advertising profile display area 816 configured to display information about a plurality of advertisements that may be configured (i.e., created or selected) for presentation in association with the web page. The advertising profile display area 816 may be further configured to provide additional information (e.g., title, status, number of impressions (historic or desired), number of clicks (historic or desired), click-through-rate, average cost-per-click, budget and position) as desired. Screen display 800 additionally includes a selectable “save” button 814 for initiating storage of a created or selected advertisement and its associated information and a “reset” button 812 for resetting any information that has been input and not stored. Methods for configuring advertisements for display are known to those of ordinary skill in the art and, accordingly, are not further described herein.

With reference back to FIG. 4, an indication is subsequently received that configuration of the advertisement is complete, as indicated at block 412, and the advertisement is stored in association with the user's account, as indicated at block 414. Referring back to FIG. 8, such indication may be received upon user selection of the “save” indicator 814. Subsequently, the advertisement is presented in association with the web page (for example, utilizing presentation component 210 of FIG. 2), as indicated at block 416 of FIG. 4.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A method for presenting advertising information in association with a web page that is part of a plurality web pages having a relationship with one another, the method comprising:
receiving a request for advertising information about the web page from a user at the web page;
accessing the requested advertising information from a database; and
presenting the accessed advertising information in association with the web page.

2. The method of claim 1, wherein the advertising information includes one or more of an expected number of impressions, an expected click-through-rate, an expected cost-per-click, and budgeting information.

3. The method of claim 1, wherein the advertising information includes one or more of an historical number of impressions, an historical click-through-rate, an historical cost-per-click, and budgeting information.

4. The method of claim 3, wherein at least one of the historical number of impressions, the historical click-through-rate, the historical cost-per-click, and the budgeting information are specific to an advertisement previously presented in association with the web page.

5. The method of claim 3, wherein at least one of the historical number of impressions, the historical click-through-rate, the historical cost-per-click, and the budgeting information are generalized from a plurality of advertisements previously presented in association with the web page.

6. The method of claim 1, wherein the advertising information includes information about one or more advertisements that drive users to the web page.

7. The method of claim 1, further comprising verifying (304) that the user is authorized to receive the requested advertising information prior to accessing the requested advertising information.

8. The method of claim 1, wherein each of the plurality of web pages having a relationship with one another is included in an advertising/publishing network of web pages.

9. One or more computer-readable media having computer-useable instructions embodied thereon for performing the method of claim 1.

10. A method for presenting an advertisement in association with a web page that is part of a plurality of web pages having a relationship with one another, the method comprising:
receiving a request from a user at the web page to have the advertisement presented in association with the web page;
presenting, in association with the web page, a user interface for configuring the advertisement;
receiving an indication that configuration of the advertisement is complete; and
presenting the advertisement in association with the web page.

11. The method of claim 10, wherein presenting the user interface for configuring the advertisement comprises presenting the user interface for at least one of creating a new advertisement and selecting an existing advertisement.

12. The method of claim 10, further comprising verifying that the user is authorized to configure the advertisement prior to presenting the user interface for configuring the advertisement.

13. The method of claim 12, wherein verifying that the user is authorized to configure the advertisement includes accessing from a database information about at least one of an identity of the user and a preference of the user.

14. The method of claim 10, wherein each of the plurality of web pages having a relationship with one another is included in an advertising/publishing network of web pages.

15. One or more computer-readable media having computer-useable instructions embodied thereon for performing the method of claim 10.

16. A system for presenting at least one of advertising information and an advertisement in association with a web page that is part of a plurality of web pages having a relationship with one another, the system comprising:
a request receiving component for receiving a request from a user at a web page for at least one of advertising information about the web page and presentation of the advertisement in association with the web page; and
a presentation component for presenting at least one of the advertising information about the web page and the advertisement in association with the web page.

17. The system of claim 16, further comprising an accessing component for accessing from one or more databases at least one of requested advertising information and user account information.

18. The system of claim 16, further comprising a user authorization component for verifying that the user is authorized to at least one of receive the requested advertising information about the web page and configure the advertisement for presentation in association with the web page.

19. The system of claim 16, wherein the presentation component is capable of presenting, in association with the web page, a user interface for configuring the advertisement for presentation in association with the web page.

20. The system of claim 16, wherein each of the plurality of web pages having a relationship with one another is included in an advertising/publishing network of web pages.
